(19) United States
(12) Patent Application Publication
(10) Pub. No.: US 2014/0115808 A1
(43) Pub. Date: May 1, 2014

(54) Connector Apparatus for Flat Blade-Type Wiper

(71) Applicant: DONGYANG MECHATRONICS CORP., Incheon (KR)

(72) Inventors: Wi Yeong Park, Incheon (KR); Sung Jun Yoon, Incheon (KR)

(73) Assignee: Dongyang Mechatronics Corp., Incheon (KR)

(21) Appl. No.: 13/869,168

(22) Filed: Apr. 24, 2013

(30) Foreign Application Priority Data
Oct. 25, 2012 (KR) 10-2012-0119301

(51) Int. Cl. B60S 1/38

(52) U.S. Cl. CPC B60S 1/3849
USPC 15/250.32

(57) ABSTRACT

Provided is a connector apparatus for a flat blade-type wiper. The connector apparatus is disposed at a central portion in a longitudinal direction of the flat blade-type wiper. The connector apparatus includes: a body: a wiper lip receiving guide unit that is disposed under the body and includes a bottom portion open in order to receive an upper end portion of a wiper lip and both ends having hook shapes; a vertebra receiving unit that is disposed on a top surface of the body and receives therein a vertebra that elastically supports the wiper lip; and elastic hook units that protrude upward from both sides of the vertebra receiving unit, each have a hook-shaped structure formed on an upper end portion, and elastically partially support top surfaces of both sides of the vertebra received in the vertebra receiving unit.

### CROSS-REFERENCE TO RELATED PATENT APPLICATION

This application claims the benefit of Korean Patent Application No. 10-2012-0119301, filed on Oct. 25, 2012, in the Korean Intellectual Property Office, the disclosure of which is incorporated herein in its entirety by reference.

### BACKGROUND OF THE INVENTION

1. Field of the Invention

The present invention relates to a wiper blade apparatus for a vehicle, and more particularly, to a flat blade-type wiper apparatus.

2. Description of the Related Art

In general, a blade assembly for cleaning a windscreen of a vehicle is an active safety device as well as an assistance device provided to clear a driver's view by removing foreign substances or rainwater from a surface of a front windscreen of the vehicle.

In general, a blade assembly for cleaning a windscreen of a vehicle includes a wiper strip that slidably contacts the windscreen of the vehicle and is formed of elastic rubber, a vertebra that elastically supports the wiper strip, and a retainer and a connection device which are a connection assembly for firmly fixing the wiper strip to a wiper arm. In general, the retainer has a tournament structure in order to remove a contact error between the wiper strip and the windscreen of the vehicle caused by a difference in a windscreen curvature between the wiper strip and the retainer. In the tournament structure, there is a space between the wiper strip and the retainer. As conditions of expressways have been improved and performances of vehicles have been improved in recent years, problems of a conventional blade assembly for cleaning a windscreen of a vehicle have been pointed out. That is, when a wiper operates while a vehicle is running at a high speed of 160 km/hour or more, a lift force may be applied to the conventional blade assembly and thus the conventional blade assembly may not correctly contact a windscreen of the vehicle, thereby failing to remove foreign substances or rainwater. In order to solve these problems, there is a demand for a blade assembly for cleaning a windscreen of a vehicle without a retainer.

A wiper apparatus called a “flat blade” has recently attracted attention as a device for preventing damage to a wiper while a vehicle is running at a high speed. In a flat blade-type wiper apparatus, a vertebra that supports a wiper lip is configured as a spoiler-lever integration type, and a connector apparatus for connecting a wiper arm is disposed at a central portion of the vertebra. An example of the flat blade-type wiper apparatus is disclosed in KR 2011-0074552.

However, in order for a conventional connector apparatus to be coupled to a vertebra disposed under the conventional connector apparatus, the conventional connector apparatus is coupled to the vertebra by being cocked or bent in a state where a leg-type structure is coupled to the vertebra. Accordingly, the conventional connector apparatus coupled to the vertebra may not be able to be physically separated from the vertebra. Since the conventional connector apparatus may not be able to be separated from the vertebra when the connector apparatus needs to be exchanged while a wiper apparatus is being used, it is inconvenient to use the conventional connector apparatus. Also, when the conventional connector apparatus is broken, a consumer has to exchange the entire wiper apparatus, thereby increasing exchange costs. Also, since the conventional connector apparatus has to be cocked or bent during an assembly process, assemblability is poor.

### SUMMARY OF THE INVENTION

In order to solve the problems, the present invention provides a connector apparatus for a flat blade-type wiper which may improve assemblability by being easily detached from a vertebra that supports a wiper lip, may facilitate a post management by being easily separated, and may reduce the burden of costs on a consumer.

According to an aspect of the present invention, there is provided a connector apparatus for a flat blade-type wiper, wherein the connector apparatus is disposed at a central portion in a longitudinal direction of the flat blade-type wiper, the connector apparatus including: a body: a wiper lip receiving guide unit that is disposed under the body and includes a bottom portion open in order to receive an upper end portion of a wiper lip and both ends having hook shapes; a vertebra receiving unit that is disposed on a top surface of the body and receives therein a vertebra that elastically supports the wiper lip; and elastic hook units that protrude upward from both sides of the vertebra receiving unit, each have a hook-shaped structure formed on an upper end portion, and elastically partially support top surfaces of both sides of the vertebra received in the vertebra receiving unit.

A plurality of the elastic hook units may be provided to be spaced apart from one another in a longitudinal direction of the wiper lip.

A plurality of the wiper lip receiving guide units may be provided to be spaced apart from one another in a longitudinal direction of the wiper lip.

### BRIEF DESCRIBTION OF THE DRAWINGS

The above and other features and advantages of the present invention will become more apparent by describing in detail exemplary embodiments thereof with reference to the attached drawings in which:

FIG. 1 is a perspective view illustrating a connector apparatus for a flat blade-type wiper, according to an embodiment of the present invention;

FIG. 2 is; a perspective view illustrating a lower structure of the connector apparatus of FIG. 1;

FIG. 3 is a side view illustrating the flat blade-type wiper employing the connector apparatus of FIG. 1;

FIG. 4 is a cross-sectional view taken along line IV-IV of FIG. 3; and

FIG. 5 is an enlarged view illustrating a structure of the flat blade-type wiper employing the connector apparatus of FIG. 1.

### DETAILED DESCRIBTION OF THE INVENTION

The present invention will now be described more fully with reference to the accompanying drawings, in which exemplary embodiments of the invention are shown.

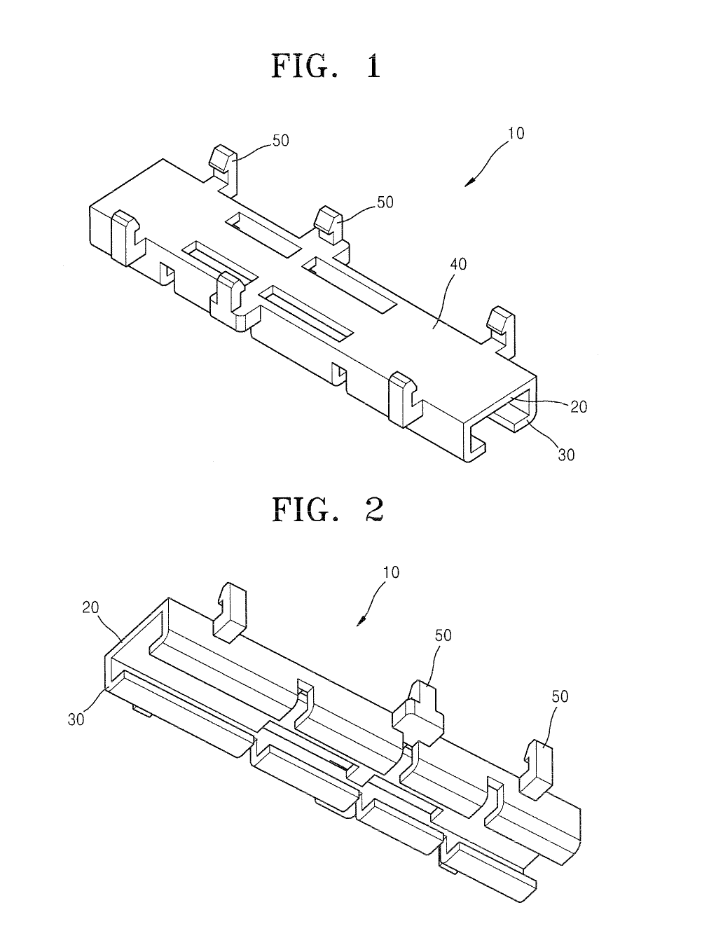

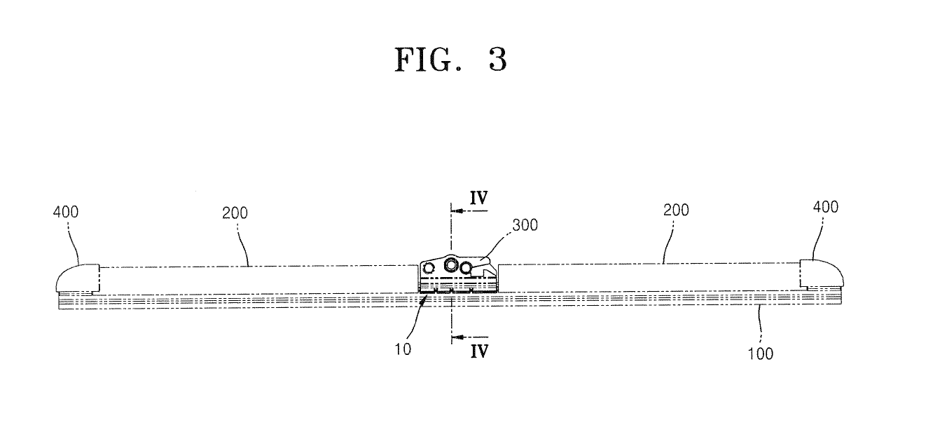

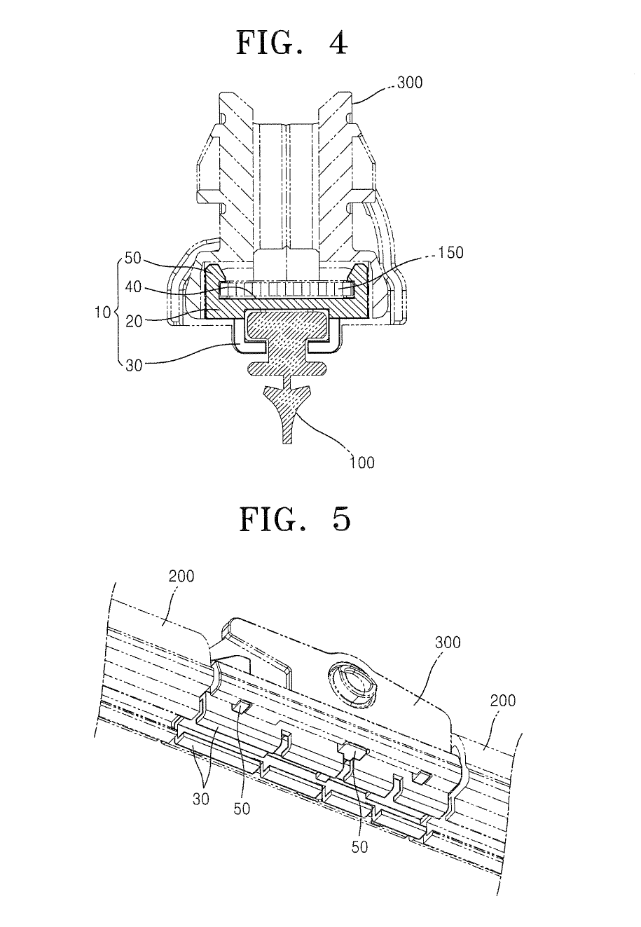

FIG. 1 is a perspective view illustrating a connector apparatus for a flat blade-type wiper, according to an embodiment of the present invention. FIG. 2 is a perspective view illustrating a lower structure of the connector apparatus of FIG. 1. FIG. 3 is a side view illustrating the flat blade-type wiper employing the connector apparatus of FIG. 1. FIG. 4 is a cross-sectional view taken along line IV-IV of FIG. 3. FIG. 5 is an enlarged view illustrating a structure of the flat blade-type wiper employing the connector apparatus of FIG. 1.

Referring to FIGS. 1 through 5, a connector apparatus 10 for a flat blade-type wiper (hereinafter, referred to as a “connector apparatus”) according to an embodiment of the present invention is disposed at a central portion in a longitudinal direction of a flat blade-type wiper. The connector apparatus 10 is a basic structure for connecting a wiper arm (not shown). The connector apparatus 10 is rotatably coupled to the wiper arm by means of a separate arm connection member 300. A coupling structure between the arm connection member 300 and the wiper arm is well known and thus a detailed description thereof will not be given.

The connector apparatus 10 includes a body 20, a wiper lip receiving guide unit 30, a vertebra receiving unit 40, and an elastic hook unit 50.

The body 20 has a bar-like shape. The body 20 may be made of, for example, a metal material such as an aluminum alloy or carbon steel. If necessary, the body 20 may be formed of a synthetic resin such as acrylobutadienestyrene (ABS).

The wiper lip receiving guide unit 30 is formed under the body 20. A lower portion of the wiper lip receiving guide unit 30 is open in order to receive an upper end portion of a wiper lip 100. Both ends of the wiper lip receiving guide unit 30 have hook shapes in order to support the upper end portion of the wiper lip 100. A plurality of the wiper lip receiving guide units 30 are provided. The wiper lip receiving guide units 30 are spaced apart from one another in a longitudinal direction of the wiper lip 100. Each of the wiper lip receiving guide units 30 is formed of a non-elastic structure. That is, the wiper lip receiving guide unit 30 has a rigid structure, unlike the elastic hook unit 50 which will be described below. The wiper lip receiving guide unit 30 receives the upper end portion of the wiper lip 100 and supports the upper end portion of the wiper lip 100 together with spoiler integration-type levers 200 that are disposed on both sides of the connector apparatus 10.

The vertebra receiving unit 40 is disposed on a top surface of the body 20. The vertebra receiving unit 40 supports a bottom surface of a vertebra 150 that elastically supports the wiper lip 100.

A pair of the elastic hook units 50 protrude upward from both sides of the vertebra receiving unit 40. A hook-shaped structure is formed on an upper end portion of each of the elastic hook units 50. The hook-shaped structure elastically partially supports top surfaces of both sides of the vertebra 150 received in the vertebra receiving unit 40. The elastic hook unit 50 plays a key role in easily coupling or separating the connector apparatus 10 to or from the vertebra 150. A plurality of the elastic hook units 50 are provided. The elastic hook units 50 are spaced apart from one another in the longitudinal direction of the wiper lip 100. Each of the elastic hook units 50 is formed of an elastic structure. That is, the elastic hook unit 50 has an elastic structure, unlike the wiper lip receiving guide unit 30. In detail, although both the elastic hook unit 50 and the wiper lip receiving guide unit 30 have cantilever structures, only the elastic hook unit 50 may be elastically deformed in terms of a width or a thickness.

An operation and an effect of the connector apparatus 10 constructed as described above will now be explained.

Referring to FIG. 3, a flat blade-type wiper apparatus employing the connector apparatus 10 is illustrated. That is, the wiper lip 100 is longitudinally disposed under the connector apparatus 10. The spoiler integration-type levers 20 in which the vertebra 150 and the wiper lip 100 are received are disposed on both sides of the connector apparatus 10. End caps 400 are coupled to both ends of the vertebra 150. The end caps 400 beautify an outer appearance of the flat blade-type wiper apparatus, and prevent the wiper lip 100 from being separated from the vertebra 150 and the spoiler integration-type levers 200.

A process of assembling the connector apparatus 10 will now be explained. The spoiler integration-type levers 200 are respectively coupled to both sides of the vertebra 150. The vertebra 150 and the spoiler integration-type levers 200 are coupled to each other by inserting the vertebra 150 into the spoiler integration-type levers 200 along grooves formed in the spoiler integration-type levers 200. In a state where the two spoiler integration-type levers 200 are coupled to the vertebra 150, a central portion of the vertebra 150 is empty. The vertebra receiving unit 40 of the connector apparatus 10 is disposed to face the bottom surface of the vertebra 150. In this state, an external force is applied to the connector apparatus 10 such that the vertebra receiving unit 40 gets closer to the bottom surface of the vertebra 150. An upper end of the elastic hook unit 50 is deformed to become wider, and thus the vertebra 150 is coupled to the vertebra receiving unit 40. The elastic hook unit 50 partially supports both side surfaces and a top surface of the vertebra 150, and thus the vertebra 150 and the connector apparatus 10 are firmly coupled to each other. The wiper lip 100 is assembled with the spoiler integration-type levers 200 by being pushed in a longitudinal direction of the spoiler integration-type levers 200. An upper end portion of the wiper lip 100 is assembled with the spoiler integration-type levers 200 having the same cross-sectional structure as that of the wiper lip receiving guide unit 30 of the connector apparatus 10, passes through the wipe receiving guide unit 30, and is coupled to the spoiler integration-type levers 200 which are disposed on the opposite side of the wiper lip 100. In this state, the end caps 400 are respectively coupled to both sides of the vertebra 150. A separate arm connection member 300 is coupled to the connector apparatus 10. The wiper arm and the flat blade-type wiper apparatus are coupled to each other by means of the arm connection member 300.

A process of separating the connector apparatus 10 from the vertebra 150 will now be explained in detail. That is, it is assumed that the connector apparatus 10 is damaged during use and thus is exchanged.

The end caps 400 are separated from both ends of the vertebra 150. The wiper lip 100 is pulled in a longitudinal direction of the vertebra 150. When the wiper lip 100 is separated from the wiper lip receiving guide unit 30 of the connector apparatus 10, the external force applied to the wiper lip 100 is removed. The arm connection member 300 coupled to the connector apparatus 10 is separated from the connector apparatus 10. In this state, when an external force is applied to the elastic hook unit 50 by using an appropriate tool such as a driver, the elastic hook unit 50 is elastically deformed to become wider. In this state, the connector apparatus 10 is separated from the vertebra 150 by applying a force such that the vertebra receiving unit 40 and the bottom surface of the vertebra 150 get farther away from each other. According to this process, the connector apparatus 10 is easily separated from the vertebra 150. A process of exchanging the connector apparatus 10 is completed by repeatedly performing the process of coupling a new connector apparatus 10 to the vertebra 150.

Since a connector apparatus according to the present invention may be easily coupled and separated to and from a vertebra by using an elastic hook unit, assemblability of the connector apparatus is much better than that of a conventional connector apparatus. Also, since the conventional connector apparatus is coupled to a vertebra by being cocked or bent, it is impossible to exchange the conventional connector apparatus. However, since the connector apparatus according to the present invention may be easily exchanged according to a user's needs, serviceability is much better than that of the conventional connector apparatus. Also, since the connector apparatus which is one of a plurality of parts constituting a wiper apparatus may be exchanged and thus the entire wiper apparatus does not need to be exchanged, the burden of costs on a consumer is reduced and the burden of costs on a manufacturer is also reduced.

As such, a connector apparatus for a flat blade-type wiper according to the present invention may greatly improve assemblability and post serviceability and reduce the burden of costs on a consumer by including an elastic hook unit that may be easily coupled and separated to and from a vertebra.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A connector apparatus for a flat blade-type wiper, wherein the connector apparatus is disposed at a central portion in a longitudinal direction of the flat blade-type wiper, the connector apparatus comprising:
a body:
a wiper lip receiving guide unit that is disposed under the body and comprises a bottom portion open in order to receive an upper end portion of a wiper lip and both ends having hook shapes;
a vertebra receiving unit that is disposed on a top surface of the body and receives therein a vertebra that elastically supports the wiper lip; and
elastic hook units that protrude upward from both sides of the vertebra receiving unit, each have a hook-shaped structure formed on an upper end portion, and elastically partially support top surfaces of both sides of the vertebra received in the vertebra receiving unit.

2. The connector apparatus of claim 1, wherein a plurality of the elastic hook units are provided to be spaced apart from one another in a longitudinal direction of the wiper lip.

3. The connector apparatus of claim 1, wherein a plurality of the wiper lip receiving guide units are provided to be spaced apart from one another in a longitudinal direction of the wiper lip.
